(19) United States
(12) Patent Application Publication
(10) Pub. No.: US 2009/0228298 A1
(43) Pub. Date: Sep. 10, 2009

(54) SYSTEM AND METHOD OF MORPHOLOGY FEATURE ANALYSIS OF PHYSIOLOGICAL DATA

(75) Inventor: Joel Q. Xue, Germantown, WI (US)

Correspondence Address: Andrus, Sceales, Starke & Sawall, LLP, 100 East Wisconsin Avenue, Suite 1100, Milwaukee, WI, 53202-4178, US

(73) Assignee: The General Electric Company, Schnectady, NY (US)

(21) Appl. No.: 12/042,192

(22) Filed: Mar. 4, 2008

(51) Int. Cl. G06Q 50/00

(52) U.S. Cl. 705/2

(57) ABSTRACT

A system and method of analyzing physiological data morphology includes a first physiological data source. A morphological segment detection module receives first physiological data from the first physiological data source and applies at least one algorithm to identify at least one morphological segment of the first physiological data. A segment feature rating module applies at least one algorithm to the at least one identified morphological segment to identify at least one segment feature to produce rating of the severity of the at least one segment feature.

### FIELD OF THE DISCLOSURE

The present disclosure relates to the field of physiological data analysis. More specifically the present disclosure relates to the detection and analysis of morphological features of physiological data.

### BACKGROUND

Automatic and semi-automatic analysis of physiological data are important tools used in both medical and clinical research applications. In automatic analysis, one or more algorithms are applied to the physiological data to produce a computer generated interpretation and/or analysis of the physiological data. Semi-automatic analysis similarly applies one or more algorithms to the physiological data to produce a computer generated interpretation or analysis of the physiological data, but the computer generated interpretation is then presented to a clinician who reviews the interpretation and edits them on a computer screen according to the clinician's own review of the data and judgment in an interactive process.

Typically, analysis of physiological data can be performed by looking at either interval related features of the physiological data (i.e. the timing between features or events in the physiological data) or the morphology of the features in the physiological data (i.e. the shape or geometry of the features in the physiological data). Most automatic and semi-automatic physiological data analysis applications focus on interval related physiological data characteristics as these characteristics are easier to identify and quantify as opposed to the feature morphologies that are more subjective in detection and analysis. While algorithms exist for the detection and description of feature morphologies, these algorithms often produce outputs that consist of a prohibitively large number of parameters and typically express each of these parameters as a continuous value such as an integer or floating point value.

Therefore, the sheer number of morphological parameters and the continuous nature of the expression of each of these parameters make it difficult to use a semi-automatic physiological data analysis technique for the analysis of data feature morphology.

### BRIEF DISCLOSURE

A system for the interactive analysis of morphological features of physiological data between computerized algorithms and review physicians is disclosed herein. In one embodiment, the system includes a morphological segment detection module that receives physiological data from a physiological data source and applies at least one morphological segment of the physiological data. The system further includes a segment feature rating module that applies at least one algorithm to the at least one identified morphological segment to identify at least one segment feature and produce a rating of the severity of the at least one segment feature.

Also disclosed herein is a method of analyzing physiological data morphology. The method includes the steps of receiving physiological data and identifying at least one morphological segment of the physiological data. The method further includes the steps of identifying at least one feature of each identified morphological segment and determining a feature rating for each identified feature.

### BRIEF DESCRIPTION OF THE DRAWINGS

FIG. 1 depicts an embodiment of a system for the analysis of morphological features of physiological data;

FIGS. 2a and 2b depict embodiments of the presentation of morphological features of a P-wave segment of electrocardiographic (ECG) data;

FIGS. 3a and 3b depict morphological features of a QRS segment of ECG data;

FIGS. 4a and 4b depict morphological features of a T-wave segment of ECG data;

FIG. 5a is a flow chart depicting the steps in an embodiment of a method of analyzing physiological data morphology;

FIG. 5b is a flow chart depicting the steps in an embodiment of a sub-method of analyzing physiological data morphology to allow clinician review and editing;

FIG. 5c is a flow chart depicting the steps in an embodiment of a sub-method of analyzing physiological data morphology to compare sets of ECG data; and

FIG. 5d is a flow chart depicting the steps in an embodiment of a sub-method of analyzing physiological data morphology to perform data mining analysis.

### DETAILED DISCLOSURE

The detection and analysis of morphological features of physiological data is an important tool in both medical diagnosis and clinical research applications. One such application is the analysis of electrocardiographic data (ECG) which will herein be used in an exemplary manner; however, it should be understood that other types of physiological data such as, but not limited to, electromyography (EMG) and electroencephalography (EEG) may be aided by embodiments of the system and method as disclosed herein.

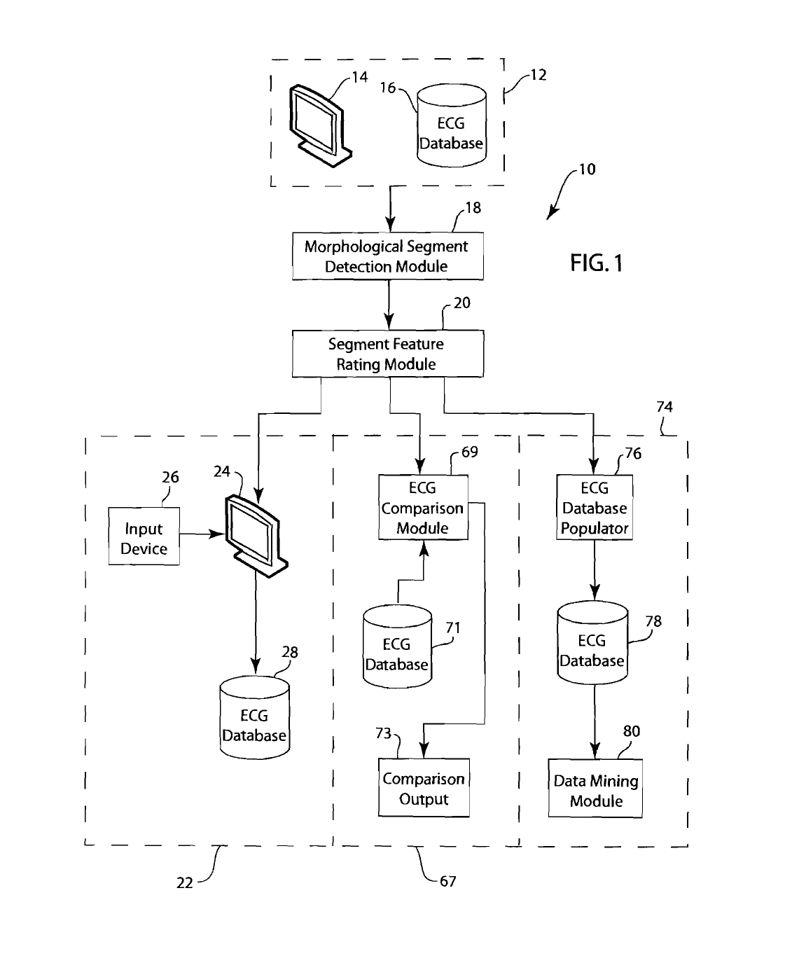

FIG. 1 depicts an embodiment of a system 10 for morphology feature analysis of physiological data. More specifically, the physiological data is ECG data. The ECG data is provided by an ECG data source 12. The ECG data source 12 may be a cardiograph 14 that is connected to a patient (not depicted) and collects ECG data from the patient. Alternatively, the ECG data source 12 may be an ECG database 16, the ECG database 16 being populated with historic ECG data that may have been collected at other times from one or more patients and stored in the database.

The ECG data from the ECG data source 12 is sent to a morphological segment detection module 18. The morphological segment detection module 18 receives the ECG data and applies at least one algorithm to the ECG data. The results of the application of the at least one algorithm is to identify at least one morphological segment of the ECG data. The morphological segments that may be identified in the ECG data may include the P-wave, the QRS complex, the ST interval, the T-wave, or the U-wave. It is understood that alternative embodiments analyzing other physiological data may detect different morphological segments intrinsic to the physiological data being analyzed. The algorithms applied by the morphological segment detection module 18 may include a series of morphology descriptors that identify each of the ECG segments. These descriptors may be used in conjunction with pattern recognition techniques to identify each of the segments.

Some embodiments herein disclosed may utilize one or more computers that apply one or more algorithms as disclosed herein to process data. The technical effect of these algorithms applied by at least one computer is to identify the morphological segments and segment features exhibited by the data and produce a rating of the identified segment features to simplify a clinician's review and editing of a computer determined analysis of a physiological signal.

The ECG data with the detected segments is then sent to a segment feature rating module 20. The segment feature rating module 20 applies at least one algorithm to at least one identified morphological segment of the ECG data. The application of the at least one algorithm to the at least one identified morphological segment produces a rating of the severity at least one segment feature. Each of the identified morphological segments may be broken into a number of segment features which may be used to describe the morphological segment. Each of the features may reflect a potential segment morphology that may be clinically relevant. A fuzzy clustering technique may be used to quantify the existence of the features in the morphological segment. These feature ratings may be quantified into discrete severity levels such as to produce a rating of the severity of any detected segment features.

In an embodiment, the discrete severity levels may include four levels represented by the numbers 0, 1, 2, and 3. These severity level ratings may coincide with no, moderate, obvious, and severe ratings for the existence of a particular segment feature. The severity levels for each feature are generated from statistical analysis of the baseline distribution for these segment features. The baseline distribution may be acquired from a large pool of ECG data as a part of one or more databases. From this baseline distribution, clustering and/or fuzzy logic grouping techniques may be applied to generate the discrete severity levels.

Embodiments of the physiological data analysis system 10 disclosed herein may include specific elements directed towards particular applications facilitated by the identification of a discrete severity level for identified segment features performed by the morphological segment detection module 18 and the segment feature rating module 20.

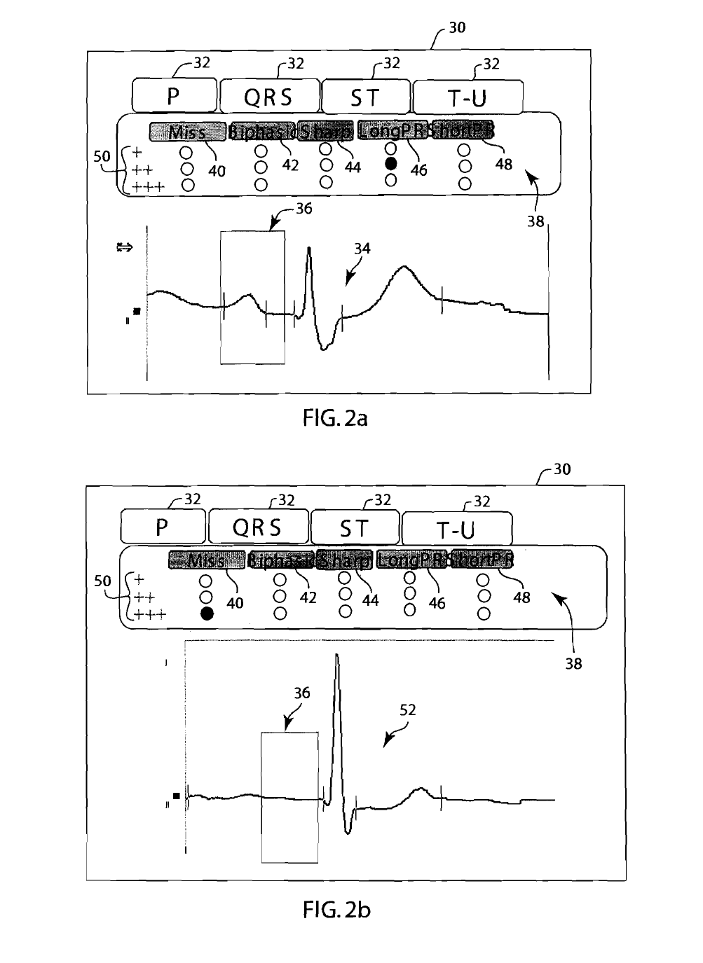

One embodiment of the system 10 may include a clinician review and editing sub-system 22 in which the ECG data with rated segment features is sent to an ECG display 24. The ECG data and the identified discrete severity levels for each identified segment feature are presented to a clinician. FIGS. 2a-4b are exemplary embodiments of the display of ECG data and the discrete segment feature severity levels. As illustrated in FIG. 1, an input device 26 is connected to the ECG display 24. A clinician reviewing the display of ECG data and the rated segment features for each morphological segment may select a morphological segment and adjust the computer determined discrete severity level for any or all of the segment features. The adjustments to the rating level made by the clinician may include the identification of additional segment features or the removal of segment features as false positives. Once the segment feature rating levels have been modified by the clinician, the ECG data and the modified segment feature ratings may be stored in an ECG database 28, or the newly modified morphology features can be used for a new analysis of interpretation and classification. The ECG database 28 may be connected to a larger hospital information network (not depicted) that connects various computer terminals and computing devices to one or more centralized servers and/or digital data storage within the hospital.

FIGS. 2a and 2b show an exemplary embodiment of the presentation of ECG data and the segment feature ratings as may be presented by the ECG display 24. FIGS. 2a and 2b may be embodied as graphical user interfaces 30 that are presented by ECG display 24. Each of the GUIs 30 may have a plurality of tabs 32 which are associated with each of a plurality of morphological segment. As the “P” tab 32 is highlighted, this indicates that the P-wave morphological segment is of focus by the current presentation of the GUI 30. The ECG data 34 is displayed as part of the GUI 30 and the P-wave morphological segment 36 is highlighted, indicating the morphological segment that is currently under review.

A segment feature rating region 38 of the GUI 30 includes indications of a plurality of segment features that may be identified within the morphological segment. An exemplary listing of the segment features may include, but is not limited to, Missing 40, Biphasic 42; Sharp 44; Long PR; and Short PR 48. The segment feature rating region 38 also includes a plurality of discrete levels 50 within which the segment features are rated. The discrete levels 50 may include “+” for moderate levels; “++” for obvious features; and “+++” for very severe features. In this fashion, each of the segment features may be indicated as being present or not present, and if they are present, then a discrete level of the severity of the feature is similarly presented.

In FIG. 2a the P-wave 36 of the ECG data 34 exhibits a Long PR feature. As this feature falls into the obvious category by the computer implemented algorithms, such is noted by the highlighted “++” circle under the Long PR segment feature. If the reviewing clinician reviews this ECG data and determines that the P-wave only exhibits a moderately Long PR then the clinician may select the P-wave tab and then select the “moderate” severity level for the Long PR 46 segment feature. This modification, along with any additional modifications, may be stored as a new morphological segment feature analysis in conjunction with the ECG data. Similarly, FIG. 2b depicts different ECG data 52, however the P-wave 36 is still highlighted on the ECG data 52. Since the highlighted P-wave 36 is nonexistent, the “Missing” segment feature includes a highlighted circle at the “very severe” or “+++” level.

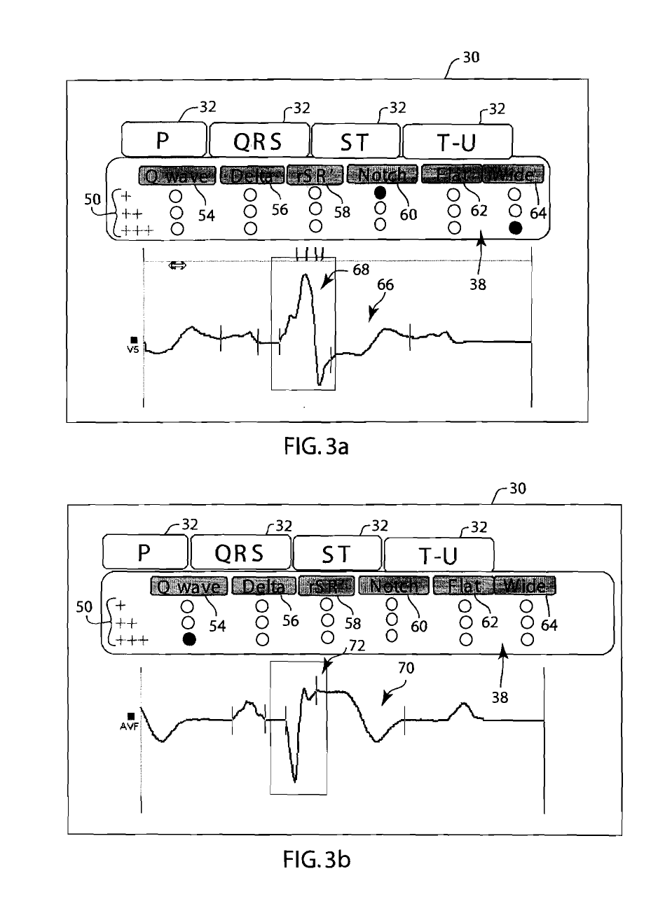

The clinician is able to review each of the identified morphological segments for the ECG data. In one embodiment, this is performed by selecting a variety of tabs 32 that are each associated with a different morphological segment. FIGS. 3a and 3b each depict GUIs 30 within which the “QRS” tab 32 has been selected. Different segment features are associated with the QRS complex as the depolarization process in the heart cycle; therefore, the segment feature rating region 38 displays a variety of new segment features, each of these associated with the QRS complex. These segment features may include the Q-wave 54; delta 56; rSR′ 58; notch 60; flat 62; and wide QRS 64.

In FIG. 3a the ECG data 66 displayed in the GUI 30 has the QRS complex 68 highlighted. The QRS complex 68 exhibits both a “moderate” (“+”) notch feature 60 and a “very severe” (“+++” ) wide feature 64. These are indicated by highlighting the proper circles associated with the discrete feature rating levels.

FIG. 3b depicts still further ECG data 70 with the QRS complex 72 highlighted. In this example, the QRS complex 72 exhibits a “very severe” Q-wave feature. It is indicated as such in the segment feature rating region 38 by highlighting the circle associated with the “very severe” segment feature rating. As described with respect to FIG. 2, a clinician may review a presentation of ECG data and computer identified rating levels as in FIGS. 3a or 3b and modify the segment feature rating levels displayed in the segment feature rating region 38 in order to adjust the output of the previous application of the algorithms to the ECG data. Any clinician modifications may be saved to the ECG database 28 such that they may be available at a later time and at a remote location to a later reviewing clinician.

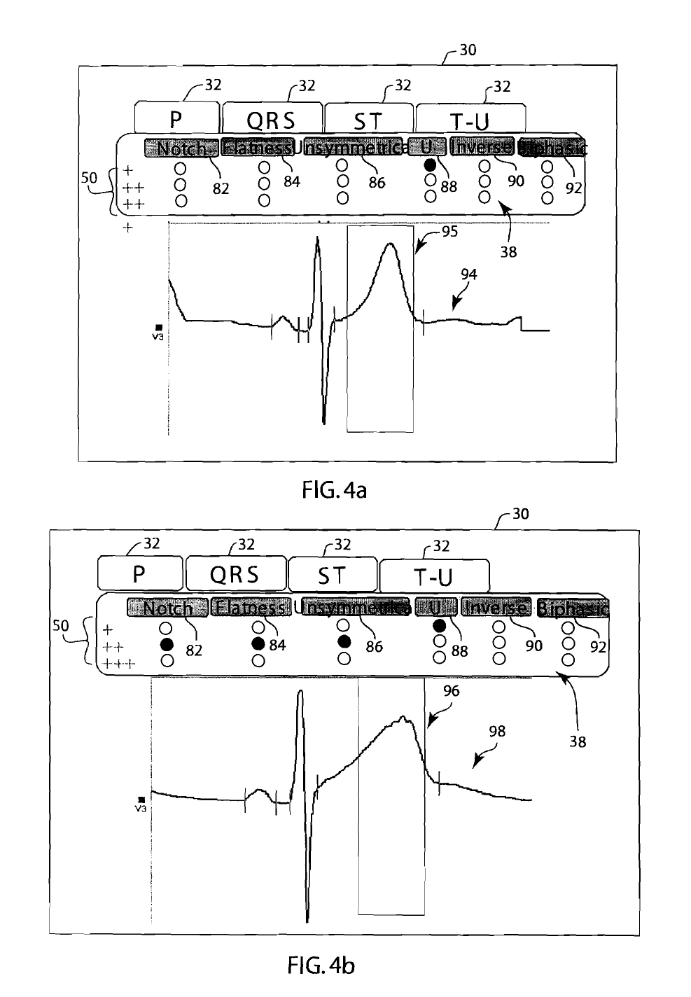

Additionally, FIGS. 4a and 4b each depict GUI's 30 within which the “T-U wave” tab 32 has been selected, which together with ST segment cover whole repolarization process in the heart cycle. Different segment features are associated with the T-wave as opposed to the QRS complex or the P-wave; therefore, the segment feature rating region 38 displays a variety of new segment features, each of these associated with the T-wave. The segment features associated with the T-wave may include a notch 82; flatness 84; unsymmetrical 86; U 88; inverse 90; and biphasic 92.

In FIG. 4a the ECG data 94 displayed in the GUI 30 has the T-wave 95 highlighted. The T-wave 95 only exhibits a “moderate” (“+”) U feature 88. The proper discrete feature level is indicated by highlighting the (“+”) circle under the U feature 88. There are no other abnormal morphology features identified for this segment of the ECG data 94.

FIG. 4b depicts still further ECG data 98 with the T-wave 96 highlighted. In this example, the T-wave 96 has been identified by the morphological feature analysis algorithm to exhibit “obvious” notch 82, flatness 84, and unsymmetrical 86 features as well as the same “moderate” U feature 88 found in ECG data 94. However, a comparison of the ECG data 94 and the ECG data 98 yields that the T-wave 95 appears to be very different from T-wave 96. In fact, the clinician, upon viewing the ECG 98 as presented by the GUI 30, may determine that the T-wave 96 of the ECG data 98 exhibits a “very severe” unsymmetrical feature as opposed to the computer determined “obvious” level of the unsymmetrical feature 86. The clinician may then select the T-wave segment 96 and change the unsymmetrical feature 86 rating level to that which the clinician determines to be more proper.

Similarly, upon a review of the ECG data 94 in comparison to the ECG data 98, the clinician may decide that T-wave 95 only presents a “moderate” unsymmetrical feature 86. The clinician may at that time choose to select the T-wave 95 segment and change the segment feature rating for the unsymmetrical feature 86 to identify that feature as being only “moderate”. Any clinician modifications that have been made may be saved to the ECG database 28 such that they may be available at a later time and add a remote location to a later reviewing clinician.

By presenting the morphological feature analysis as a plurality of discrete levels for each of the predetermined clinically relevant morphological features, the clinician's review of the ECG data is focused on those features. This helps the clinician to distill the multitudes of morphological feature data that may be produced by an automated system; and, therefore, enable the clinician to effectively interject his or her own clinical opinion into the automated morphological feature analysis result. This combination of both automated and clinician analysis of the ECG data thus yields a more accurate morphological feature analysis, capitalizing on the strengths of automated systems as well as clinician review and modification of those results.

It is understood that the clinician may select any of the tabs 32 of the GUI 30 to navigate to each of the other morphological segments, including the ST segment and the T-U segment. Upon selection of these alternative segment tabs, a similar segment feature rating region 38 would be brought up that includes segment features that are associated within or particular to the selected morphological segment. Also, the selected morphological segment would be highlighted on the display of ECG data below the segment feature rating region 38.

The clinician review and editing sub-system 22 of the physiological data analysis system 10 gives the reviewing clinician the ability to review and modify an analysis or interpretation of ECG data performed by the application of algorithms to the ECG data, similar to that which is already available with respect to interval based physiological data analysis. This promotes improved quality in the final analysis of the ECG data, as the clinician is assisted by the algorithm analysis, but can adjust the output to account for algorithm identified false positives and modifications.

Referring back to FIG. 1, the ECG comparator sub-system 67 of the segment feature rating module 20 provides ECG data with the rated segment features to an ECG comparison module 69. The ECG comparison module 69 is connected to an ECG database 71. The ECG database 71 provides second ECG data that includes rated features to the ECG comparison module 69. The ECG comparison module 68 produces a comparison output 73 that is an indication of the similarities and differences between the first ECG data and the second ECG data.

In one embodiment of the ECG comparison module 69, the ECG comparison module 69 compares each of the feature ratings between the first ECG data and the second ECG data to determine the similarity and differences between the first ECG data and the second ECG data.

In a still further embodiment, the comparison between the first ECG data and the second ECG data may be performed by using a distance measure method wherein a numerical value is given to each of the discrete segment feature levels and the difference between the levels for each of the segment features is found. In one simple distance measure method, each of the differences are squared and summed. The square root of this summation is indicative of the overall difference between the two ECG signals and may be easily implemented by the application of this algorithm. It is also understood that other methods and/or algorithms may be used to provide a comparison between the first ECG data and the second ECG data as well. These alternative methods and/or techniques are considered within the scope of the present disclosure.

The data mining sub-system 74 of the physiological data analysis system 10 uses the ECG data with the rated segment features from the segment feature rating module 20 to create an improved data mining system 74. An ECG database populator 76 receives the ECG data with the rated segment features from the segment feature rating module 20. The ECG database populator 76 sorts the ECG data by the segment feature and the rated level for each segment feature. This sorted ECG data is then stored in an ECG database 78 wherein the sorted ECG data may be stored as a lookup table wherein the ECG data is tabulated by each segment feature and its rating severity level. A morphology feature based database search engine can be built by first generating a morphology index server. A data mining module 80 may access the index sever to search a specific segment feature and/or segment feature level very fast. This can easily and quickly allow the retrieval of a very specific data set comprising all of the ECG data that exhibits a specified segment feature and/or specified feature level.

Thus, the data mining system 74 can improve upon previous data mining systems in that sets of morphology based segregated ECG data may be easily acquired to enhance the application of data mining techniques that may be applied to the obtained data sets.

It should be understood that in the present disclosure the term module has been used to describe components of the physiological data analysis system 10. In the present disclosure, the term module is used to refer to a logical component of a system that is implemented in either hardware, software, or firmware that receives an input and produces an output.

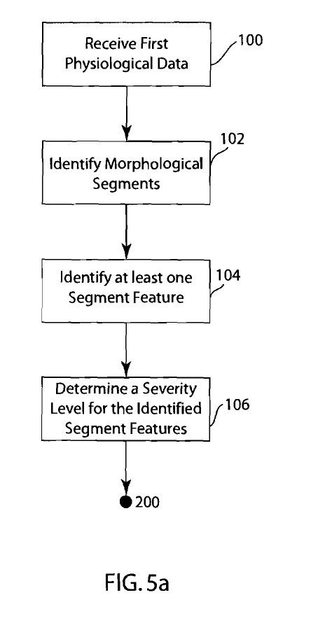

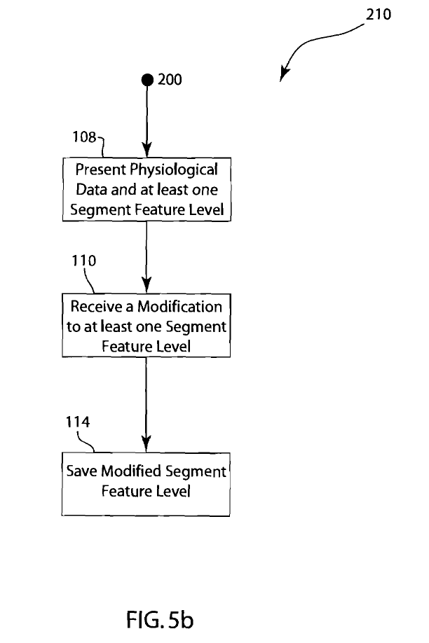

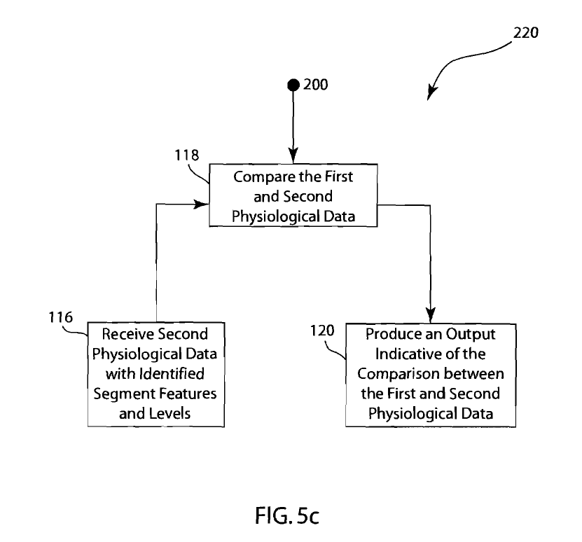

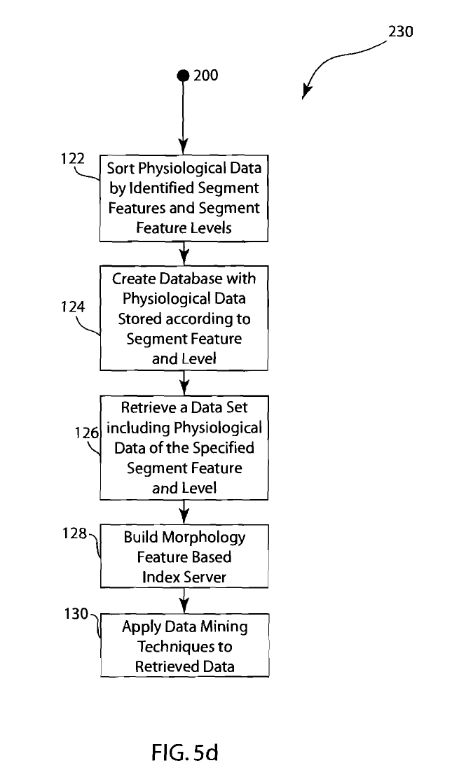

Also disclosed herein is a method of analyzing physiological data morphology, as depicted in FIGS. 5a-d. The method begins in FIG. 5a with the step of receiving first physiological data, step 100. As described above, the first physiological data may come from a database of physiological data or may be recorded from a patient using a patient monitoring device. Next, at step 102, the morphological segments in the first physiological data are identified. This may be accomplished by the application of one or more algorithms to the first physiological data such as to identify morphological segments particular to the type of physiological data being analyzed. At step 104 each morphological segment is analyzed to identify at least one segment feature from the identified morphological segments. Segment features may be common or characteristic features that may occur in one or more morphological segments. These segment features may be indicative of or correlated to particular physiological risks or conditions.

After at least one segment feature has been identified in step 104, a severity level for the identified segment features is determined at step 106. The severity level for the identified segment features may be represented by a discrete number of levels upon which the severity of the identified segment features are rated. The severity level for each of the identified segment features may be determined by the degree in which the identified segment feature deviates from a specified baseline norm for that particular segment feature. The baseline may be calculated from an analysis of exemplary physiological data.

The determined severity levels for the identified segment features of step 106 in combination with the first physiological data may be utilized in a variety of alternative sub-method applications as represented by reference point 200. These sub-methods may include clinician review and modification of the physiological data 210; serial comparison between the first physiological data and other physiological data 220; and data mining applications 230.

Referring to FIG. 5b, an embodiment of a clinician review and modification sub-method 210 for analysis and interpretation of the physiological data is depicted. The physiological data and the determined segment feature levels, at reference 200 (from step 106), are presented to the clinician at step 108. Next, the clinician reviews the physiological data and the determined segment feature levels. Upon reviewing the physiological data and the segment feature levels, if the clinician feels that one or more of the determined segment feature levels are an incorrect characterization of the physiological data, then the clinician may input, and the system receive, a modification to at least one segment feature level at step 110. By modification of the determined segment feature levels in step 110, the clinician provides increased accuracy in any forthcoming physiological analysis from the segment feature levels. The modified segment feature levels are saved at step 114 for retrieval and use by other clinicians with access to the media upon which the saved modified segment feature levels are stored.

Referring to FIG. 5c, an alterative embodiment of a data comparison sub-method 220 is depicted. The determined severity level for the identified segment features at reference 200 (from step 106) and the first physiological data are compared at step 118 to second physiological data with identified segment features and levels received at step 116. The comparison of the first and second physiological data at step 118 may include techniques that compare the first and second physiological data based upon the determined levels for each of the identified segment features alone and in combination with the other levels for the other segment features of the physiological data. More specifically, the comparison of step 118 may be performed using a sum of squares technique to compute the “distance” between the discrete levels the segment features. Finally, the result of the comparison in step 118 produces an output indicative of the comparison between the first and second physiological data at step 120. The output produced in step 120 may provide a quantitative comparison of the similarities between the first and second physiological data.

Lastly, FIG. 5d depicts a data mining sub-method 230. The physiological data and the determined severity levels for the identified segment features, at reference 200 (from step 106), are sorted in step 122 by the identified segment features and segment feature levels. Then, at step 124, the sorted physiological data is used to create a database with the physiological data stored as it was sorted according to the segment feature and level. This may create a database in which physiological data is grouped and organized not only by the morphological segment features that are identified, but of the relative severity level of each of the identified segment features.

At step 126, a data set is retrieved from the database created in step 124 that includes physiological data of a specified segment feature and level. The organization and grouping of the physiological data in the database created in step 124 facilitates the retrieval of these highly specified data sets in step 126. The data set retrieved in step 126 may then be used in step 128 to build a morphology feature based index server. The morphology based index server may be constructed in the form of a look-up table that allows for the selection and/or sequential ordering of sets of ECG data based on any of the identified morphological segment features stored with each of the sets of ECG data. It is understood, however, that other strategies for data organization and index server structure may be utilized in connection with the morphology feature based index server.

Finally, data mining techniques are applied in step 130 using the index server created in step 128. The application of data mining techniques may be facilitated by the specialized data sets that may be easily retrieved from the index server built in step 128 due to the organization and the grouping of the physiological data by the identified segment feature and the segment feature levels in the index server. Thus, the data mining techniques applied in step 130 may result in faster and more accurate results due to the efficiencies gained through the use of the morphology feature based index server.

One particular field in which the system and method as disclosed herein may be of particular relevance may be in the field of pharmaceutical cardiac safety testing. As pharmaceutical cardiac safety testing requirements increase, these tests may require more sophisticated analysis techniques that look not only at ECG data interval timing but also at ECG morphology changes, since the inclusion of ECG morphology analysis may yield a higher correlation with severe drug induced arrhythmia than simply ECG interval measurements alone. Therefore, a technique wherein clinicians are able to review ECG data and a series of computer determined segment features, segment feature severity levels, check the computer determined levels for accuracy, and modify the determined levels with the clinician's own interpretation of the ECG data would be beneficial in that the resulting ECG data with human annotated computer derived segment feature levels would be more accurate then that determined by the computer or the clinician alone.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent elements with insubstantial differences form the literal languages of the claims.

Various alternatives and embodiments are contemplated as being with in the scope of the following claims, particularly pointing out and distinctly claiming the subject matter regarded as the invention.

What is claimed is:

1. A system for the analysis of morphological features of physiological data, the system comprising:
a first physiological data source;
a morphological segment detection module that receives first physiological data from the first physiological data source and applies at least one algorithm to identify at least one morphological segment of the first physiological data; and
a segment feature rating module that applies at least one algorithm to the at least one identified morphological segment to identify at least one segment feature and produce a first rating of the severity of the at least one segment feature.

2. The system of claim 1, further comprising:
a display that receives the first physiological data and the first rating of the severity of the at least one segment feature and presents the first physiological data and the first rating to a clinician;
an input device operable to receive from a clinician a selection of the first rating and a modification to the first rating according to the clinician's interpretation of the first physiological data; and
a storage device wherein the modified first rating is stored.

3. The system of claim 1 further comprising:
a second physiological data source comprising second physiological data that includes at least one second rating of the severity of at least one segment feature of the second physiological data;
a physiological comparison module that receives the second physiological data from the second physiological data source and the first physiological data from the segment feature rating module, the physiological comparison module applying at least one algorithm to compare the first physiological data with the second physiological data, the physiological comparison module producing an output indicative of the results of the comparison.

4. The system of claim 3, wherein the at least one algorithm applied by the physiological comparison module comprises a sum of squares algorithm that provides a comparison between the first rating of the first physiological data and the second rating of the second physiological data.

5. The system of claim 1 further comprising:
a physiological database populator that receives the first physiological data and the first rating; and
a physiological database comprising a plurality of physiological data and a plurality of segment feature ratings, the physiological database storing the first physiological data in the plurality of physiological data and the first rating in the plurality of segment feature ratings;
wherein the first physiological data is stored in the physiological database according to the first rating.

6. The system of claim 5, wherein plurality of physiological data is stored in the physiological database as a look up table according to the plurality of segment feature ratings.

7. The system of claim 6 further comprising a data mining module connected to the physiological database such that the plurality of physiological data stored according to the plurality of segment feature ratings may be accessed as a data set wherein all the physiological data in the data set comprises a specified segment feature rating.

8. The system of claim 1, wherein the first physiological data source is a patient monitor that measures physiological signals from a patient.

9. The system of claim 1, wherein the first physiological data source is a database of stored physiological data.

10. A system for the analysis of the morphology of electrocardiographic (ECG) data, the system comprising:
a first ECG data source;
a morphological segment detection module that receives first ECG data from the first ECG data source and applies at least one algorithm to detect at least one morphological segment of the first ECG data; and
a segment feature rating module that applies at least one algorithm to the at least one detected morphological segment to identify at least one segment feature and produce a first rating of the severity of the at least one segment feature.

11. The system of claim 10 further comprising:
a display that receives the first ECG data and the first rating and presents the first ECG data and the first rating to a clinician;
an input device operable to receive from a clinician, upon review of the first rating on the display, a selection of the first rating and a modification to the first rating according to the clinician's interpretation of the first ECG data; and
a storage device wherein the modified first rating is stored.

12. The system of claim 10 further comprising:
a second ECG data source comprising second ECG data that includes at least one second rating;
an ECG comparison module that receives the second ECG data from the second ECG data source and the first ECG data from the segment feature rating module, the ECG comparison module applying at least one algorithm to compare the first ECG data with the second ECG data, the ECG comparison module producing an output indicative of the results of the comparison.

13. The system of claim 12 wherein the output is a hyperdistance comprising the difference between the first rating of the first physiological data and the second rating of the second physiological data.

14. The system of claim 10 further comprising:
an ECG database populator that receives the first ECG data and the first rating;
an ECG database comprising a plurality of ECG data and a plurality of segment feature ratings, the ECG database storing the first ECG data as part of the plurality of ECG data and the first rating as part of the plurality of segment feature ratings, the first ECG data being stored in the ECG database according to the first rating; and
a data mining module connected to the ECG database such that the plurality of ECG data may be accessed as a data set wherein all of the ECG data in the data set comprises a specified segment feature rating.

15. A method of analyzing physiological data morphology, the method comprising the steps of:
receiving first physiological data;
identifying at least one morphological segment of the first physiological data;
identifying at least one segment feature of each identified morphological segment; and
determining a segment feature severity level for each identified segment feature.

16. The method of claim 15 wherein the first physiological data is electrocardiographical (ECG) data.

17. The method of claim 16 further comprising the steps of:
presenting the ECG data;
presenting the at least one segment feature severity level;
receiving a modification to at least one segment feature severity level; and
saving the modified segment feature severity level.

18. The method of claim 16 further comprising the steps of:
receiving second ECG data, the second ECG data having at least one identified segment feature and at least one determined segment feature severity level;
comparing the first ECG data and second ECG data based on the identified segment features and determined segment feature severity levels; and
producing an output indicative of the results of the comparison between the first ECG data and the second ECG data.

19. The method of claim 16 further comprising the steps of:
grouping the ECG data according to the identified at least one segment feature and the determined segment feature severity level; and
creating a database with the ECG data stored according to the groups in which the ECG data was placed.

20. The method of claim 19 further comprising the steps of:
retrieving a data set from the database, the data set comprising a plurality of ECG data comprising a specified segment feature and segment feature severity level; and
applying at least one data mining technique to the retrieved data set.
